(19) United States
(12) Patent Application Publication
(10) Pub. No.: US 2019/0165423 A1
(43) Pub. Date: May 30, 2019

(54) Method for Producing an Electrochemical Cell Comprising a Lithium Electrode, and Electrochemical Cell

(71) Applicant: Bayerische Motoren Werke Aktiengesellschaft, Muenchen (DE)

(72) Inventors: Dave ANDRE, Muenchen (DE); Simon NUERNBERGER, Bad Aibling (DE); Jan-Oliver ROTH, Erding (DE); Saskia SCHNEIDER, Muenchen (DE); Dennis SCHUENEMANN, Mauern (DE); Barbara STIASZNY, Obergriesbach (DE); Christoph STINNER, Muenchen (DE); Nikolaos TSIOUVARAS, Muenchen (DE); Thomas WOEHRLE, Muenchen (DE); Tobias ZEILINGER, Muenchen (DE); Sandra ZUGMANN, Garching (DE)

(21) Appl. No.: 16/262,099

(22) Filed: Jan. 30, 2019

Related U.S. Application Data
(63) Continuation of application No. PCT/EP2017/059700, filed on Apr. 25, 2017.

(30) Foreign Application Priority Data
Aug. 4, 2016 (DE) 10 2016 214 398.0

(51) Int. Cl. H01M 10/0585; H01M 10/0525; H01M 4/40; H01M 4/36; H01M 4/38; H01M 4/04

(52) U.S. Cl. CPC H01M 10/0585; H01M 10/0525; H01M 4/405; H01M 2004/027; H01M 4/382; H01M 4/0471; H01M 4/366

(57) ABSTRACT

A method produces an electrochemical cell for a solid-state battery having a negative electrode, a positive electrode and a lithium-ion-conducting solid electrolyte arranged between the negative electrode and the positive electrode. The negative electrode has a layer of metallic lithium which directly adjoins the solid electrolyte. In order to produce the electrochemical cell, the layer of metallic lithium is heated until it softens before being joined together with the solid electrolyte. An electrochemical cell includes the negative electrode with a layer of metallic lithium which directly adjoins the solid electrolyte, and a layer of a lithium-metal alloy on the layer of metallic lithium.

### CROSS REFERENCE TO RELATED APPLICATIONS

This application is a continuation of PCT International Application No. PCT/EP2017/059700, filed Apr. 25, 2017, which claims priority under 35 U.S.C. § 119 from German Patent Application No. 10 2016 214 398.0, filed Aug. 4, 2016, the entire disclosures of which are herein expressly incorporated by reference.

### BACKGROUND AND SUMMARY OF THE INVENTION

The invention relates to a method for producing an electrochemical cell comprising a metallic lithium electrode and an electrochemical cell produced according to said method, in particular for use in a solid-state battery.

Lithium ion batteries are already in use in numerous mobile devices. In addition, these batteries can also be used in hybrid and electric vehicles and for storing the current from wind or solar power plants. The batteries can be intended as a primary battery for single use or configured as a reusable secondary battery (accumulator).

Ordinarily, lithium ion batteries consist of one or more electrochemical cells comprising a negative graphite electrode (anode in the discharging process) with a current conductor composed of copper, a positive electrode (cathode in the discharging process) composed of a transition metal oxide layer with a current conductor such as aluminum, and a separator composed of polyolefin or another plastic that is saturated with a liquid or gel-type electrolyte of an organic solvent and a lithium salt.

The energy density or the specific energy of these currently-available systems is limited by the electrochemical stability of the electrolyte and the active materials used for the electrodes. At present, liquid electrolytes can be operated with a cell voltage of up to approximately 4.3-4.4 V, which limits the theoretical potential of anode and cathode active materials.

In addition, in the event of a malfunction, a liquid electrolyte poses a greater risk because it is easily flammable. In the event of thermal runaway of the cell, it may be intensely heated, resulting in potential ignition of the electrolyte and the promotion of further harmful reactions.

In order to increase the safety of lithium ion batteries and increase their energy density, there have already been research approaches that propose replacing the liquid electrolyte with a solid electrolyte, for example on the basis of polymers such as polyethylene oxide (PEO) or ceramics based on garnet compounds. At the same time, the graphite anode is replaced with a metallic lithium anode.

One of the greatest problems in such solid-state batteries (all-solid-state cells) is the contact resistance between the electrodes and the solid electrolyte.

EP 0039409 A1 describes a solid-state battery with an alkali metal anode, in particular a potassium anode, a solid electrolyte composed of beta-aluminum oxide, and a graphite layer as a positive electrode. Because of the high operating temperature of the solid-state battery, the anode is in a liquid state. The battery is produced by pressing the various layers together and melting the alkali metal to form a coating.

EP 2086038 B1 discloses a solid-state battery with an electrochemical cell, wherein a metal oxide having a component selected from Co, Ni, Mn, Nb and Si and a maximum particle size of 0.3 μm is used as a solid electrolyte. Transition metal oxides that can store and release lithium are used as active materials for the positive and negative electrodes. Precompressed layers of the solid electrolyte, the positive electrode, and the negative electrode can be laminated and sintered into a block in order to produce the battery. A lithium film is then applied to the side of the negative electrode and reacted for approximately one week under pressure at 50° C. with the active material of the negative electrode.

The object of the invention is to provide a simple and economical method for producing an electrochemical cell for lithium ion batteries, in particular for rechargeable lithium batteries. Moreover, an electrochemical cell having a simple structure is to be provided.

This object is achieved by a method and an electrochemical cell in accordance with embodiments of the invention.

In order to improve the interface contact between the metallic lithium used on the side of the negative electrode (anode) and the solid electrolyte, it is proposed to heat the surface of the lithium film and to slightly melt or soften it. After this, the film is brought into contact with the solid electrolyte under slight contact pressure.

After the molten lithium film solidifies, an improved interface contact is formed between the metallic lithium film and the solid electrolyte. In materials that tend to form a passivation layer in contact with lithium by chemical reaction (a solid electrolyte interface or SEI layer), this layer can be formed during production of the electrochemical cell. This makes it possible to dispense with the step of selective construction of the SEI layer by initial charging of the lithium battery.

According to the invention, a method is thus provided for producing at least one electrochemical cell of a solid-state battery that comprises a negative electrode with a layer of metallic lithium, a positive electrode, and a lithium-ion-conducting solid electrolyte arranged between the negative electrode and the positive electrode, wherein the method comprises the following steps:
providing the negative electrode;
providing the positive electrode;
providing a substrate composed of the solid electrolyte with a first surface and a second surface that is opposite the first surface; and
joining together of the substrate with the positive electrode on the first surface and the negative electrode on the second surface so that the solid electrolyte lies between the negative electrode and the positive electrode and the layer of metallic lithium is opposite the second surface, characterized in that the layer of metallic lithium is heated until it softens before being joined together with the substrate on at least one surface opposite to the second surface of the substrate.

According to a preferred embodiment, heating of the layer of metallic lithium can be carried out by means of induction heating, heating with a heating device such as e.g. an oven, passage of hot gases such as e.g. argon, or by means of heated rollers, for example during a rolling process.

Preferably, the layer of metallic lithium is heated to a temperature of at least approximately 60° C., preferably approximately 120° C., more preferably at least 140° C. or at least 160° C., and particularly preferably to the melting point of the lithium film at approximately 180° C. However, it is not necessary to melt or soften the lithium film throughout its entire thickness. It is sufficient for a boundary layer to be melted or softened to the extent that the solid electrolyte is moistened with the lithium metal to a sufficient degree.

Heating of the layer of metallic lithium before it is joined together with the solid electrolyte results in improved contact between the lithium metal and the solid electrolyte and thus to a lower interface resistance. The improved interface resistance allows a higher average voltage to be applied and the usable power of the battery to be increased. Moreover, the load on the materials at the interface is substantially lower, so that manufacturing defects due to mechanical influences can be avoided. The method according to the invention also improves the service life of the cell due to the improved and lasting adhesion.

The materials known from the prior art can be used as a solid electrolyte for the electrochemical cell produced according to the invention. In particular, the solid electrolyte shows favorable conductivity for lithium ions at room temperature, but poor electron conductivity. Preferably, the electron conductivity of the solid electrolyte is less than 1×10⁻⁸ S/cm. Examples of suitable solid electrolytes are in particular lithium phosphate oxynitride (LIPON), lithium halide, lithium nitride, lithium-sulfur and lithium-phosphorus compounds, and mixed compounds and derivatives thereof. Further suitable are oxide compounds composed of lithium, oxygen, and at least one further element, preferably but not limited to Ti, Si, Al, Ta, Ga, Zr, La, N, F, Cl and S. In addition, solid electrolytes based on lithium sulfide and glasses composed of lithium sulfide and/or boron sulfide are described that can be doped with further elements such as phosphorus, silicon, aluminum, germanium, gallium, tin, or indium, such as e.g. Li₁₀SnP₂S₁₂. In addition, polymer-based solid electrolytes such as polyethylene oxide and polyvinylidene fluoride can be used, which contain lithium salts. Hybrids of solid electrolytes can also be used that are composed of two or more of the above-mentioned materials.

Suitable as active materials for the positive electrode are also all materials described in the prior art, particularly transition metal compounds that can store and release lithium ions. Examples of suitable active materials for use as a positive electrode are lithium cobalt dioxide, lithium manganese dioxide, and mixed oxides of lithium, nickel, manganese and/or cobalt such as LiNi_{0.33}Co_{0.33}Mn_{0.33}O₂, Li_{1+z}Ni_{1-x-y}CoₓMn_{y}O₂, and LiNi₁₋ₓCoₓO₂. Further described are NMC derivatives such as LiNi_{0.85}Co_{0.1}Al_{0.05}O₂, spinels such as LiMn₂O₄, and olivines such as e.g. lithium iron phosphate LiFePO₄ or LiMₓN_{y}PO₄₋ᵥZᵥ, where M and N=Fe, Mn, Ni and Co and Z=F and OH. In addition to the oxide active materials, so-called conversion materials, preferably from the class of fluorides and sulfides, such as FeF₃, can also be used.

According to a particularly preferred embodiment, the electrochemical cell comprises a negative electrode with a layer of metallic lithium that is directly adjacent to the solid electrolyte, and a layer of a lithium-metal alloy on the layer of metallic lithium. The metal of the lithium-metal alloy is preferably selected from the group composed of indium, aluminum, silicon, magnesium, germanium and gallium and combinations thereof.

Preferably, the lithium-metal alloy contains the metal in an amount of 0.00001 to 30 wt %, with the remainder being lithium and unavoidable impurities. Particularly preferably, the metal is contained in the lithium-metal alloy in an amount of 0.0001 to 10 wt %, and most preferably 0.001 to 2 wt %.

The layer of the lithium-metal alloy can preferably be used as a current conductor of the negative electrode. In this case, no further metal is arranged on the layer of the lithium-metal alloy. In this embodiment, the layer of metallic lithium serves as a lithium source and at the same time as a bonding agent between the solid electrolyte and the lithium-metal alloy used as a current conductor of the negative electrode.

In a further embodiment, a conventional current conductor, for example composed of copper or nickel, can be provided on the lithium-metal alloy. The lithium-metal alloy then serves as an active electrode material for the negative electrode.

The negative electrode preferably has a layer thickness of 0.001 mm to 1 mm. Lithium films of these layer thicknesses are commercially available or can be produced by means of vacuum processes. Preferably, high-purity lithium with a degree of purity of >98% is used, particularly preferably with a degree of purity in the range of 99.8-99.9%. When metallic lithium is used together with a lithium-metal alloy as a negative electrode, the layer thickness of the metallic lithium can be in the range of 0.00001 mm to 0.9 mm. Alternatively, it is conceivable to apply the layer of metallic lithium as a thin layer with a thickness of 10 nm to 1 μm to the layer of the lithium-metal alloy. The layer thickness of the lithium-metal alloy is preferably in the range of 0.0009 to 1 mm.

In order to produce the electrochemical cell with a negative electrode comprising metallic lithium, a layer stack is formed from the metallic lithium and the lithium-metal alloy, which are heated together, for example using an induction heater, hot gases such as argon, or heated rollers, wherein the heat source is preferably arranged on the side of the layer stack on which the metallic lithium is located. The metallic lithium is thus locally melted, and the negative electrode is pressed or laminated in this state onto the solid electrolyte or a prefabricated stack of the solid electrolyte and the positive electrode, and optionally a current conductor for the positive electrode. The preferably high-purity lithium is softened by the heating and conforms to the brittle and rough solid electrolyte so that the contact and adhesion to the solid electrolyte is improved and the interface resistance is reduced. The metallic lithium thus serves simultaneously as an anode and a bonding agent in order to impart to the electrochemical cell a longer service life and high current-carrying capacity.

In addition, by using a lithium-metal alloy as a current conductor, it is possible to achieve better compatibility between the negative electrode composed of metallic lithium and the current conductor. The lithium-metal alloy used as a current conductor is easier to handle or process because of its superior mechanical properties, such as high mechanical strength. Moreover, even small amounts of other metals can improve handling during production. For example, the punchability of the lithium-metal alloy is improved over that of a lithium film because fewer cutting burrs are produced. In the further processing of the lithium-metal alloy, there are fewer smudges or mechanical defects. Advantageously, the current conductor composed of the lithium-metal alloy can serve as an additional lithium source for the electrochemical cell, as the lithium contained in the alloy can also migrate into the solid electrolyte. This also results in an increase in specific energy.

Other objects, advantages and novel features of the present invention will become apparent from the following detailed description of one or more preferred embodiments when considered in conjunction with the accompanying drawing.

### BRIEF DESCRIPTION OF THE DRAWING

FIG. 1 is a schematic structure of an electrochemical cell according to an embodiment of the invention.

### DETAILED DESCRIPTION OF THE DRAWING

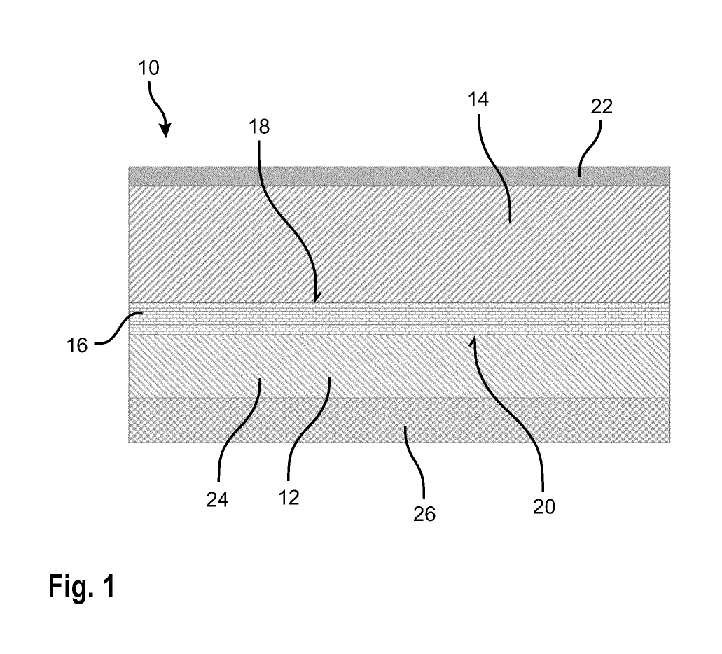

The electrochemical cell 10 or solid-state battery shown in FIG. 1 comprises a negative electrode 12, a positive electrode 14, and a lithium-ion-conducting solid electrolyte 16 arranged between the negative electrode 12 and the positive electrode 14. The negative electrode 12 and the positive electrode 14 are arranged on opposite surfaces 18, 20 of the solid electrolyte 16.

The solid electrolyte 16 is preferably composed of oxide or sulfide lithium ion conductors. As an active material for the positive electrode 14, transition metal oxides such as Li(Ni_{1/3}Co_{1/3}Mn_{1/3})O₂ or conversion materials such as FeF₃ are preferably used. The current conductor 20 provided on the positive electrode 14 is preferably composed of aluminum.

The negative electrode 12 comprises a layer of metallic lithium 24 that directly adjoins the solid electrolyte 16. Preferably, high-purity metallic lithium with a degree of purity in the range of 99.8-99.9% is used. A layer of a lithium-metal alloy 26 is arranged on the layer of metallic lithium 24. The entire layer thickness of the negative electrode composed of the lithium layer 24 and the layer of the lithium-metal alloy 26 is preferably 0.001 mm to 1 mm.

The metal of the lithium-metal alloy can be selected from the group composed of indium, aluminum, silicon, germanium and gallium and combinations thereof, and may be present in an amount of 0.00001 to 30 wt %.

In the embodiment shown here, the layer of the lithium-metal alloy 26 serves simultaneously as a current conductor for the negative electrode 12 and as a lithium source.

In order to produce the electrochemical cell 10 comprising a negative electrode 12 containing metallic lithium, a film of high-purity lithium is provided. The lithium film is heated on one side, for example using an induction heater, heated rollers, or hot air. This causes the metallic lithium to be softened or locally melted over a portion of the film thickness.

In the next step, the heated lithium film is pressed onto the solid electrolyte 16 or a prefabricated stack composed of the solid electrolyte 16 and the positive electrode 14 and optionally a current conductor 22 for the positive electrode 14, wherein the heated or molten part of the lithium film is opposite the solid electrolyte 16. In this manner, the lithium film and the solid electrolyte 16 are firmly connected to each other. The high-purity lithium is softened by heating and conforms to the brittle and rough solid electrolyte so that the contact with the solid electrolyte is improved and the interface resistance is reduced.

Instead of the lithium film, one can also use a layer stack with a layer of a lithium-metal alloy 26 and a layer of high-purity lithium 24. The heat source is then arranged on the side of the layer stack on which the metallic lithium 24 is located. In this manner, one obtains an electrochemical cell as shown in FIG. 1 in which the layer of the lithium-metal alloy 26 can simultaneously serve as a current conductor. Optionally, a conventional current conductor, for example of copper or nickel, can be applied to the layer of the lithium-metal alloy (not shown).

Multiple electrochemical cells produced in this way are bundled by a conventional method into blocks, electrically connected to one another, and encapsulated in a housing to form a solid-state battery. The solid-state battery can be used as a primary or secondary (rechargeable) battery. Particularly preferred is use in motor vehicles with hybrid or electric drive or as a stationary energy storage unit.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A method for producing an electrochemical cell for a solid-state battery comprising a negative electrode with at least one layer of metallic lithium, a positive electrode and a lithium-ion-conducting solid electrolyte arranged between the negative electrode and the positive electrode, the method comprising the steps of:
providing the negative electrode;
providing the positive electrode;
providing a substrate composed of the solid electrolyte with a first surface and a second surface that that is opposite the first surface;
joining together of the substrate with the positive electrode on the first surface and the negative electrode on the second surface, so that the solid electrolyte lies between the negative electrode and the positive electrode and the layer of metallic lithium is opposite the second surface,
wherein the layer of metallic lithium, before being joined together with the substrate, is heated until it softens on at least one surface opposite the second surface of the substrate.

2. The method as claimed in claim 1, wherein
heating of the layer of metallic lithium is carried out by induction heating, heating with a heating device, hot gas, or heated rollers.

3. The method as claimed in claim 1, wherein
the layer of metallic lithium is heated to a temperature of at least 60° C.

4. The method as claimed in claim 1, wherein
the layer of metallic lithium is heated to a temperature of at least 120° C.

5. The method as claimed in claim 1, wherein
the layer of metallic lithium is heated until at least a part of the metallic lithium melts.

6. The method as claimed in claim 5, wherein
the layer of metallic lithium is melted only over a part of the layer thickness.

7. The method as claimed in claim 1, wherein
the negative electrode has a layer thickness of 0.001 mm to 1 mm.

8. The method as claimed in claim 1, wherein
the negative electrode is composed of a layer stack with the layer of metallic lithium and a layer of a lithium-metal alloy.

9. The method as claimed in claim 8, wherein
the layer of the metallic lithium in the layer stack has a thickness of 0.00001 to 0.9 mm.

10. The method as claimed in claim 9, wherein
the layer of the metallic lithium in the layer stack has a thickness of 10 nm to 1 μm.

11. An electrochemical cell for a solid-state battery, comprising:
a negative electrode;
a positive electrode; and
a lithium-ion-conducting solid electrolyte arranged between the negative electrode and the positive electrode, wherein
the negative electrode comprises a layer of metallic lithium that is directly adjacent to the solid electrolyte and a layer of a lithium-metal alloy on the layer of metallic lithium.

12. The electrochemical cell as claimed in claim 11, wherein
the metal of the lithium-metal alloy is selected from the group consisting of: indium, aluminum, silicon, magnesium, germanium, gallium, and combinations thereof.

13. The electrochemical cell as claimed in claim 11, wherein
the lithium-metal alloy is composed of the metal in an amount of 0.00001 to 30 wt %, with the remainder being lithium and unavoidable impurities.

14. The electrochemical cell as claimed in claim 11, wherein
the lithium-metal alloy comprises the metal in an amount of 0.0001 to 10 wt %.

15. The electrochemical cell as claimed in claim 11, wherein
the lithium-metal alloy comprises the metal in an amount of 0.001 to 2 wt %.

16. The electrochemical cell as claimed in claim 11, wherein
no further metal layer is applied to the layer of the lithium-metal alloy.

17. The electrochemical cell as claimed in claim 11, wherein
a further metal layer is applied to the layer of the lithium-metal alloy as a current conductor.
